(19) United States
(12) Patent Application Publication
(10) Pub. No.: US 2025/0211650 A1
(43) Pub. Date: Jun. 26, 2025

(54) APPLICATION DOWNLOAD METHOD, SERVER, ELECTRONIC DEVICE, AND SYSTEM

(71) Applicant: Huawei Technologies Co., Ltd., Shenzhen (CN)

(72) Inventor: Wei Long, Hangzhou (CN)

(21) Appl. No.: 19/074,699

(22) Filed: Mar. 10, 2025

Related U.S. Application Data
(63) Continuation of application No. PCT/CN2023/134487, filed on Nov. 27, 2023.

(30) Foreign Application Priority Data
Dec. 21, 2022 (CN) 202211647230.8

(51) Int. Cl. H04L 67/00

(52) U.S. Cl. CPC H04L 67/34

(57) ABSTRACT

An application download method, a server, an electronic device, and a system. The method includes receiving, by a server, a first application download request sent by an electronic device, where the first application download request carries device information of the electronic device and information about a first application that is requested to be downloaded, determining, based on the information about the first application, a first application package corresponding to the first application, performing, by the server, unpacking processing on the first application package based on the device information, splitting an entry package in the first application package into a basic package and another resource package, where the basic package comprises a set of resources for running the first application by the electronic device, and sending the basic package to the electronic device.

### CROSS-REFERENCE TO RELATED APPLICATIONS

This application is a continuation of International Patent Application No. PCT/CN2023/134487, filed on Nov. 27, 2023, which claims priority to Chinese Patent Application No. 202211647230.8, filed on Dec. 21, 2022. The disclosures of the aforementioned applications are hereby incorporated by reference in their entireties.

### TECHNICAL FIELD

Embodiments of this application relate to the field of terminal technologies, and in particular, to an application download method, a server, an electronic device, and a system.

### BACKGROUND

As terminal technologies advance, functions that can be implemented by applications become more diversified, leading a corresponding increase in a size of an application package. Thus, time consumed for downloading the application package also increases accordingly.

Currently, some electronic devices may provide an installation-free application service for a user. When the electronic device starts an installation-free application for the first time in response to a user operation, the user does not perceive an installation process of the application. This requires a size of an application package of the installation-free application to be small, to provide better installation-free application use experience for the user.

However, currently, because the size of the application package is large, time consumed for the installation process of the application package of the installation-free application increases, affecting user experience.

### SUMMARY

To resolve the foregoing technical problem, this application provides an application download method, a server, an electronic device, and a system. According to technical solutions provided in this application, the server splits an application package of a to-be-downloaded application based on information about the electronic device that requests to download the application, and retains a resource corresponding to the electronic device in the application package. This avoids downloading an unnecessary resource and reduces a size of the application package, thereby increasing a download speed of the application package and reducing time consumed for installing the application.

To achieve the foregoing technical objective, this application provides the following technical solutions.

According to a first aspect, an application download method is provided, and is applied to a server. The method includes receiving a first application download request sent by an electronic device, where the first application download request carries device information of the electronic device and information about a first application that is requested to be downloaded, determining, based on the information about the first application, a first application package corresponding to the first application, performing unpacking processing on the first application package based on the device information, and splitting an entry package in the first application package into a basic package and another resource package, where the basic package includes a set of resources for running the first application by the electronic device, and sending the basic package to the electronic device.

In this way, the server splits the application package, and retains a running resource that is required by the electronic device to run the application and that is for the electronic device to download, which reduces a size of the application package and avoids downloading a redundant resource, thereby increasing an application download speed. In addition, a waste of download traffic caused by downloading the redundant resource can be avoided.

It should be understood that retention of the running resource ensures that the electronic device can normally run the application after the application is downloaded, thereby effectively improving a speed at which the electronic device starts the application for the first time, reducing waiting duration of a user, and meeting an application use requirement of the user.

In addition, a decrease in the size of the application package also reduces storage space occupied by the application package on the electronic device, so that performance of the electronic device is improved.

According to the first aspect, the method further includes performing unpacking processing on the basic package, and splitting the basic package into a home page package and a non-home page package, where the home page package includes a set of resources for opening a home page of the first application, and the non-home page package includes a set of resources for opening a function page of the first application.

For example, after obtaining an installation package of an application A based on an application download request, the server parses the installation package of the application A, to determine the entry package included in the installation package of the application A. Then, the server may split the entry package based on the device information carried in the application download request, and split the entry package into different resource packages. Then, the server may determine a running resource corresponding to the device information, and pack the running resource into the basic package, that is, finally split the entry package into the basic package and the another resource package.

For example, the server determines that resolution resources in the entry package include a 1024×1024 resolution resource, a 256×256 resolution resource, and the like. The server determines that a resolution of the electronic device is 1024×1024 based on the device information of the electronic device. In this case, in a process of splitting the entry package, the server may split the 1024×1024 resolution resource that is included in the entry package into the running resource, and subsequently pack the running resource into the basic package. In this way, the electronic device subsequently downloads the basic package to install the application, and does not need to download an unnecessary resolution resource.

According to the first aspect or any one of the foregoing implementations of the first aspect, the sending the basic package to the electronic device includes sending the home page package to the electronic device, where the home page package is used by the electronic device to start the first application and display the home page of the first application.

For example, the server splits a resource file based on a resource index file, and splits main basic resources that are included in the resource file into the home page package. These main basic resources are the set of resources for opening the home page of the application. In addition, the server may retain a code file, in the basic package, in the home page package. Then, the server may split other remaining basic resources, in the resource file of the basic package, into the non-home page package. These other basic resources are the set of resources for opening the function page of the application.

In this way, the server splits the basic package, and retains the set of resources for opening the home page of the application by the electronic device, so that application startup efficiency is further improved while it is ensured that the application is started and the home page is displayed.

According to the first aspect or any one of the foregoing implementations of the first aspect, after the sending the home page package to the electronic device, the method further includes receiving a second application download request sent by the electronic device, where the second application download request is a request sent by the electronic device during or after installation of the home page package, and sending the non-home page package to the electronic device in response to the second application download request, where the non-home page package is used by the electronic device to display the function page of the first application.

In some examples, the second application download request is, for example, a download request sent by the electronic device after the electronic device determines that the home page package of the first application is downloaded. Alternatively, the second application download request is, for example, a download request sent by the electronic device in response to a user operation. The user operation, for example, indicates to display another function page of the first application.

In this way, there is no need to wait until the home page package is downloaded and installed before downloading of the non-home page package. Instead, an installation process of the home page package and a download process of the non-home page package are performed in parallel, so that overall time for downloading and installing the home page package and the non-home page package is reduced, thereby reducing time for starting the application and further reducing waiting time for subsequent running of the application.

According to the first aspect or any one of the foregoing implementations of the first aspect, the device information includes one or more of a device type, a language type, a processor model, and a resolution.

According to a second aspect, an application download method is provided, and is applied to an electronic device. The method includes sending a first application download request to a server in response to a first operation of a user, where the first application download request carries device information of the electronic device and information about a first application that the first operation indicates to download, receiving a basic package sent by the server based on the first application download request, where the basic package includes a set of resources that are in an entry package of the first application and that are used by the electronic device to run the first application, and displaying the first application based on the basic package.

According to the second aspect, the receiving a basic package sent by the server based on the first application download request includes receiving a home page package sent by the server, where the home page package includes a set of resources that are in the basic package and that are used to open a home page of the first application.

According to the second aspect or any one of the foregoing implementations of the second aspect, after the receiving a home page package sent by the server, the method further includes installing the home page package, sending a second application download request to the server during or after the installation of the home page package, and receiving a non-home page package sent by the server, where the non-home page package includes a set of resources that are in the basic package and that are used to open a function page of the first application.

According to the second aspect or any one of the foregoing implementations of the second aspect, the displaying the first application based on the basic package includes displaying the home page of the first application based on the home page package.

According to the second aspect or any one of the foregoing implementations of the second aspect, the method further includes in a process of displaying the home page of the first application, detecting a second operation of the user, and jumping, based on the non-home page package, to the function page of the first application that the second operation indicates to display.

According to the second aspect or any one of the foregoing implementations of the second aspect, before the sending a second application download request to the server, the method further includes in a process of displaying the home page of the first application, detecting a third operation of the user, where the third operation indicates to jump to the function page of the first application.

For technical effect corresponding to the second aspect and any one of the implementations of the second aspect, refer to technical effect corresponding to the first aspect and any one of the implementations of the first aspect. Details are not described herein again.

According to a third aspect, a server is provided. The server includes a processor and a memory. The memory is coupled to the processor. The memory is configured to store computer program code. The computer program code includes computer instructions. When the processor reads the computer instructions from the memory, the server is enabled to receive a first application download request sent by an electronic device, where the first application download request carries device information of the electronic device and information about a first application that is requested to be downloaded, determine, based on the information about the first application, a first application package corresponding to the first application, perform unpacking processing on the first application package based on the device information, and split an entry package in the first application package into a basic package and another resource package, where the basic package includes a set of resources for running the first application by the electronic device, and send the basic package to the electronic device.

According to the third aspect, when the processor reads the computer instructions from the memory, the server is further enabled to perform unpacking processing on the basic package, and split the basic package into a home page package and a non-home page package, where the home page package includes a set of resources for opening a home page of the first application, and the non-home page package includes a set of resources for opening a function page of the first application.

According to the third aspect or any one of the foregoing implementations of the third aspect, the sending the basic package to the electronic device includes sending the home page package to the electronic device, where the home page package is used by the electronic device to start the first application and display the home page of the first application.

According to the third aspect or any one of the foregoing implementations of the third aspect, when the processor reads the computer instructions from the memory, the server is further enabled to receive a second application download request sent by the electronic device, where the second application download request is a request sent by the electronic device during or after installation of the home page package, and send the non-home page package to the electronic device in response to the second application download request, where the non-home page package is used by the electronic device to display the function page of the first application.

According to the third aspect or any one of the foregoing implementations of the third aspect, the device information includes one or more of a device type, a language type, a processor model, and a resolution.

For technical effect corresponding to the third aspect and any one of the implementations of the third aspect, refer to technical effect corresponding to the first aspect and any one of the implementations of the first aspect. Details are not described herein again.

According to a fourth aspect, an electronic device is provided. The electronic device includes a processor, a display, and a memory. The memory and the display are coupled to the processor. The memory is configured to store computer program code. The computer program code includes computer instructions. When the processor reads the computer instructions from the memory, the electronic device is enabled to send a first application download request to a server in response to a first operation of a user, where the first application download request carries device information of the electronic device and information about a first application that the first operation indicates to download, receive a basic package sent by the server based on the first application download request, where the basic package includes a set of resources that are in an entry package of the first application and that are used by the electronic device to run the first application, and display the first application based on the basic package.

According to the fourth aspect, the receiving a basic package sent by the server based on the first application download request includes receiving a home page package sent by the server, where the home page package includes a set of resources that are in the basic package and that are used to open a home page of the first application.

According to the fourth aspect or any one of the foregoing implementations of the fourth aspect, when the processor reads the computer instructions from the memory, the electronic device is further enabled to install the home page package, sending a second application download request to the server during or after the installation of the home page package, and receive a non-home page package sent by the server, where the non-home page package includes a set of resources that are in the basic package and that are used to open a function page of the first application.

According to the fourth aspect or any one of the foregoing implementations of the fourth aspect, the displaying the first application based on the basic package includes displaying the home page of the first application based on the home page package.

According to the fourth aspect or any one of the foregoing implementations of the fourth aspect, when the processor reads the computer instructions from the memory, the electronic device is enabled to in a process of displaying the home page of the first application, detect a second operation of the user, and jump, based on the non-home page package, to the function page of the first application that the second operation indicates to display.

According to the fourth aspect or any one of the foregoing implementations of the fourth aspect, when the processor reads the computer instructions from the memory, the electronic device is enabled to in a process of displaying the home page of the first application, detect a third operation of the user, where the third operation indicates to jump to the function page of the first application.

For technical effect corresponding to the fourth aspect and any one of the implementations of the fourth aspect, refer to technical effect corresponding to the second aspect and any one of the implementations of the second aspect. Details are not described herein again.

According to a fifth aspect, this application provides an application download system. The system includes an electronic device and a server. The electronic device is configured to send a first application download request to the server in response to a first operation of a user, where the first application download request carries device information of the electronic device and information about a first application that the first operation indicates to download. The server is configured to receive the first application download request sent by the electronic device, where the first application download request carries the device information of the electronic device and the information about the first application that is requested to be downloaded, determine, based on the information about the first application, a first application package corresponding to the first application, perform unpacking processing on the first application package based on the device information, and split an entry package in the first application package into a basic package and another resource package, where the basic package includes a set of resources for running the first application by the electronic device, and send the basic package to the electronic device. The electronic device is further configured to receive the basic package sent by the server based on the first application download request, where the basic package includes the set of resources that are in the entry package of the first application and that are used by the electronic device to run the first application, and display the first application based on the basic package.

According to the fifth aspect, the server is further configured to perform unpacking processing on the basic package, and split the basic package into a home page package and a non-home page package, where the home page package includes a set of resources for opening a home page of the first application, and the non-home page package includes a set of resources for opening a function page of the first application.

According to the fifth aspect or any one of the foregoing implementations of the fifth aspect, the server is further configured to send the home page package to the electronic device, where the home page package is used by the electronic device to start the first application and display the home page of the first application. The electronic device is further configured to receive the home page package.

According to the fifth aspect or any one of the foregoing implementations of the fifth aspect, the server is further configured to receive a second application download request sent by the electronic device, where the second application download request is a request sent by the electronic device during or after installation of the home page package, and send the non-home page package to the electronic device in response to the second application download request, where the non-home page package is used by the electronic device to display the function page of the first application.

For technical effect corresponding to the fifth aspect and any one of the implementations of the fifth aspect, refer to technical effect corresponding to the first aspect and any one of the implementations of the first aspect. Details are not described herein again.

According to a sixth aspect, this application provides a server. The electronic server has a function of implementing the application download method according to the first aspect and any one of the possible implementations of the first aspect. The function may be implemented by hardware, or may be implemented by hardware executing corresponding software. The hardware or the software includes one or more modules corresponding to the function.

For technical effect corresponding to the sixth aspect and any one of the implementations of the sixth aspect, refer to technical effect corresponding to the first aspect and any one of the implementations of the first aspect. Details are not described herein again.

According to a seventh aspect, this application provides an electronic device. The electronic device has a function of implementing the application download method according to the first aspect and any one of the possible implementations of the first aspect. The function may be implemented by hardware, or may be implemented by hardware executing corresponding software. The hardware or the software includes one or more modules corresponding to the function.

For technical effect corresponding to the seventh aspect and any of the implementations of the seventh aspect, refer to technical effect corresponding to the second aspect and any one of the implementations of the second aspect. Details are not described herein again.

According to an eighth aspect, a computer-readable storage medium is provided. The computer-readable storage medium stores a computer program (which may also be referred to as instructions or code). When the computer program is executed by a server, the server is enabled to perform the method according to the first aspect or any one of the implementations of the first aspect.

For technical effect corresponding to the eighth aspect and any one of the implementations of the eighth aspect, refer to technical effect corresponding to the first aspect and any one of the implementations of the first aspect. Details are not described herein again.

According to a ninth aspect, a computer-readable storage medium is provided. The computer-readable storage medium stores a computer program (which may also be referred to as instructions or code). When the computer program is executed by an electronic device, the electronic device is enabled to perform the method according to the first aspect or any one of the implementations of the first aspect.

For technical effect corresponding to the ninth aspect and any of the implementations of the ninth aspect, refer to technical effect corresponding to the second aspect and any one of the implementations of the second aspect. Details are not described herein again.

According to a tenth aspect, this application provides a computer program product. When the computer program product runs on a server, the server is enabled to perform the method according to the first aspect or any one of the implementations of the first aspect.

For technical effect corresponding to the tenth aspect and any one of the implementations of the tenth aspect, refer to technical effect corresponding to the first aspect and any one of the implementations of the first aspect. Details are not described herein again.

According to an eleventh aspect, this application provides a computer program product. When the computer program product runs on an electronic device, the electronic device is enabled to perform the method according to the second aspect or any one of the implementations of the second aspect.

For technical effect corresponding to the eleventh aspect and any one of the implementations of the eleventh aspect, refer to technical effect corresponding to the second aspect and any one of the implementations of the second aspect. Details are not described herein again.

According to a twelfth aspect, this application provides a circuit system. The circuit system includes a processing circuit. The processing circuit is set to perform the method according to the first aspect or any one of the implementations of the first aspect, or the processing circuit is set to perform the method according to the second aspect or any one of the implementations of the second aspect.

For technical effect corresponding to the twelfth aspect and any one of the implementations of the twelfth aspect, refer to technical effect corresponding to the first aspect and any one of the implementations of the first aspect. Details are not described herein again.

According to a thirteenth aspect, this application provides a chip system, including at least one processor and at least one interface circuit. The at least one interface circuit is configured to perform a transceiver function, and send instructions to the at least one processor. When the at least one processor executes the instructions, the at least one processor performs the method according to the first aspect or any one of the implementations of the first aspect, or the at least one processor performs the method according to the second aspect or any one of the implementations of the second aspect.

For technical effect corresponding to the thirteenth aspect and any one of the implementations of the thirteenth aspect, refer to technical effect corresponding to the first aspect and any one of the implementations of the first aspect. Details are not described herein again.

### BRIEF DESCRIPTION OF THE DRAWINGS

FIG. 1 is a diagram 1 of an application package download scenario according to an embodiment of this application;

FIG. 2 is a diagram of a communication system to which an application download method is applied according to an embodiment of this application;

FIG. 3 is a diagram of a hardware structure of a server according to an embodiment of this application;

FIG. 4 is a diagram of a hardware structure of an electronic device according to an embodiment of this application;

FIG. 5(a) and FIG. 5(b) are a diagram of interfaces according to an embodiment of this application;

FIG. 6 is a diagram 1 of an application package unpacking scenario according to an embodiment of this application;

FIG. 7A and FIG. 7B are a diagram 2 of an application package unpacking scenario according to an embodiment of this application;

FIG. 8 is a diagram 2 of an application package download scenario according to an embodiment of this application;

FIG. 9 is a schematic flowchart of an application download method according to an embodiment of this application;

FIG. 10 is a diagram of a structure of a server according to an embodiment of this application; and

FIG. 11 is a diagram of a structure of an electronic device according to an embodiment of this application.

### DETAILED DESCRIPTION OF ILLUSTRATIVE EMBODIMENTS

The following describes the technical solutions in embodiments of this application with reference to the accompanying drawings in embodiments of this application. In the descriptions of embodiments of this application, terms used in the following embodiments are merely intended for a purpose of describing specific embodiments, but are not intended to limit this application. The terms “one”, “a”, “the”, “the foregoing”, “this”, and “the one” of singular forms used in this specification and the appended claims of this application are intended to include expressions such as “one or more”, unless otherwise specified in the context clearly. It should be further understood that in the following embodiments of this application, “at least one” and “one or more” mean one or more than two (including two).

Reference to “an embodiment”, “some embodiments”, or the like described in this specification indicates that one or more embodiments of this application include a specific feature, structure, or characteristic described with reference to the embodiment. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “comprise”, and “have”, and variants thereof all mean “include but are not limited to”, unless otherwise specifically emphasized in another manner. The term “connection” includes a direct connection and an indirect connection, unless otherwise stated. “First” and “second” are merely intended for a purpose of description, and shall not be understood as an indication or implication of relative importance or implicit indication of a quantity of indicated technical features.

In embodiments of this application, the word “example”, “for example”, or the like is used to represent giving an example, an illustration, or a description. Any embodiment or design scheme described as an “example” or “for example” in embodiments of this application should not be explained as being more preferred or more advantageous than another embodiment or design scheme. Exactly, use of the word “example”, “for example”, or the like is intended to present a related concept in a specific manner.

In some scenarios, as a quantity of application functions increase, a size of an application package increases accordingly, and the increase in the size of the application package directly affects a download speed of an application. The application package is, for example, an application package of a common application or an installation-free application. The common application includes, for example, an application that a user can choose to install or uninstall, such as an application like Health, AI Life, Notepad, or the like. The installation-free application includes, for example, a quick application or an applet. After the user triggers an operation of starting an installation-free application that has not been installed, an electronic device may display a page loading animation on an interface, and correspondingly download and install the installation-free application. Therefore, the user can visually see that a corresponding page is being loaded and displayed. However, the user usually does not perceive that the installation-free application is being downloaded or installed.

In some examples, after the installation-free application is downloaded and installed, a home page of the installation-free application may be displayed.

In some examples, a process of downloading and installing the installation-free application consumes less time, and therefore the application installation process is not perceived by the user. During use, the user may directly start the application by tapping an icon, a card, or a link, thereby providing better use experience for the user.

It should be understood that, from a perspective of an operating system, for the installation-free application, the electronic device still needs to download the application package to install the application. From a perspective of the user, the user does not perceive the installation of the application, and therefore does not actively uninstall the installation-free application.

However, currently, the size of the installation-free application package is still large. Therefore, it takes a long time for the electronic device to install the application package for the first time, and the user waits for a long time, which affects user experience.

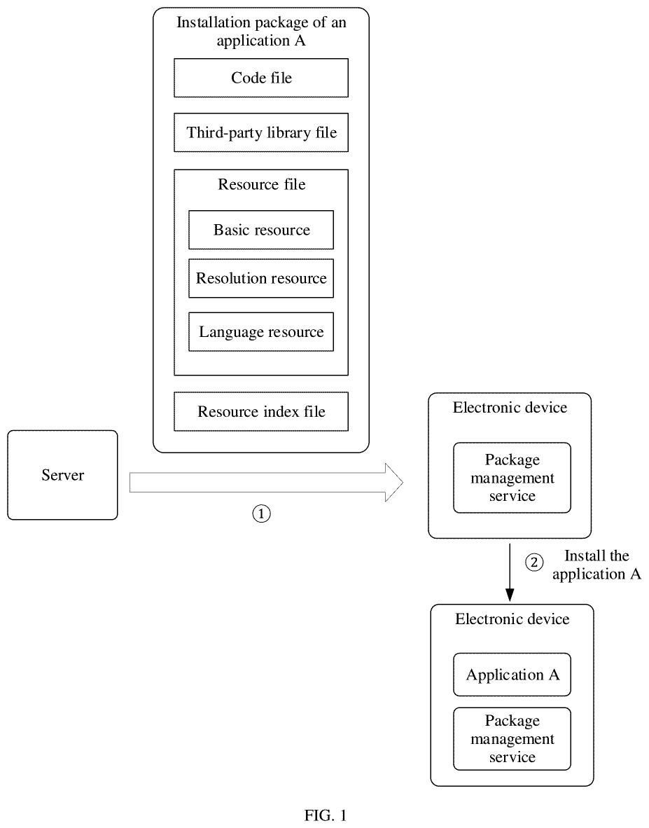

For example, as shown in FIG. 1, an installation package of an application A may include a code file, a third-party library file, a resource file, and a resource index file. The code file includes code that supports running of the application A. The third-party library file includes a third-party library that supports the running of the application A. For example, the third-party library is set to implement an automatic text translation function and the like of the corresponding application A. The resource file includes various resources that can implement a function of the application A, for example, basic resources, resolution resources, and language resources. The resource index file is used to index a corresponding resource location in the resource file.

In some examples, some installation-free applications (for example, the application A) may support a multi-language service. In this case, in the resource file in the installation package of the application A, the language resources include multi-language packages. However, during actual use, when using the application for the first time, the user may need support only of some languages of the application. In this case, among the multi-language packages included in the installation package of the application A, some language packages that are not needed for the first use exist. As a result, the size of the installation package of the application A is large, and time consumed in the process of installing the application A by the electronic device is increased. In addition, after the electronic device downloads the application A, the large installation package of the application A also occupies excessive storage space of the electronic device.

For another example, if operating systems of some electronic devices support a distributed service, in an application development process, a developer also designs an application to support the distributed service, that is, the application may be automatically adapted to use of a plurality of types of electronic devices. In this case, the size of the application package also increases, which affects implementation of quick installation and startup of the installation-free application.

Therefore, an embodiment of this application provides an application download method. A server splits an application package of a to-be-downloaded application based on information about the electronic device that requests to download the application, and retains a resource corresponding to the electronic device in the application package. This avoids downloading an unnecessary resource and reduces the size of the application package, thereby increasing a download speed of the application package and reducing time consumed for installing the application.

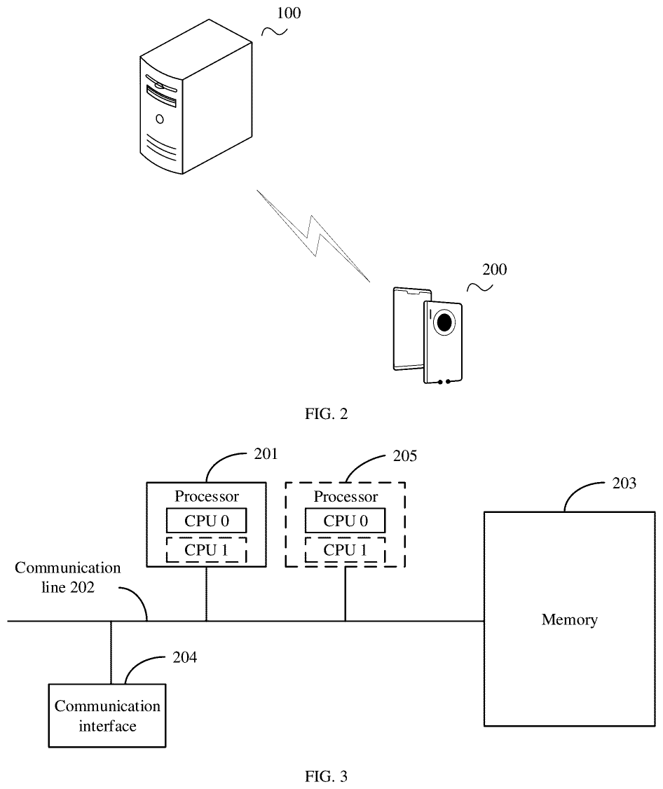

FIG. 2 is a diagram of a communication system to which an application download method is applied according to an embodiment of this application. As shown in FIG. 2, the communication system includes a server 100 and an electronic device 200.

Optionally, the server 100 may be a device or a server with a computing function, for example, a cloud server or a network server. The server may be one server, a server cluster including a plurality of servers, or a cloud computing service center.

Optionally, the electronic device 200 may be, for example, a terminal device such as a mobile phone, a tablet computer, a notebook computer, a smart screen, a vehicle-mounted terminal, an ultra-mobile personal computer (UMPC), a netbook, a personal digital assistant (PDA), a wearable device (such as a smartwatch), or an artificial intelligence (AI) device. An operating system installed in the electronic device includes but is not limited to iOS®, Android®, HarmonyOS®, Windows®, Linux®, or another operating system. A specific type of the electronic device 200 and the operating system installed in the electronic device 200 are not limited in this application.

In some embodiments, the server 100 is configured to manage an application package. For example, the server 100 is an AppGallery server. In some examples, the server 100 performs unpacking processing on the application package in response to a request of the electronic device 200, to reduce a size of the application package. Then, the server 100 delivers a corresponding application package to the electronic device 200. The electronic device 200 may complete application downloading and installation based on the obtained application package.

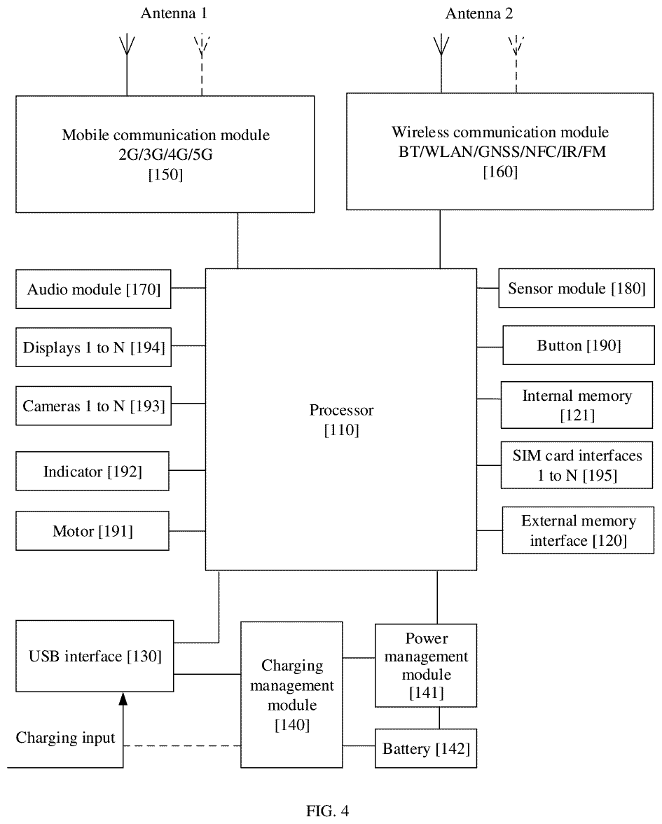

For example, FIG. 3 is a diagram of a structure of the server 100.

The server includes at least one processor 201, a communication line 202, a memory 203, and at least one communication interface 204. The memory 203 may alternatively be included in the processor 201.

The processor 201 may be a general-purpose central processing unit (CPU), a microprocessor, an application-specific integrated circuit (ASIC), or one or more integrated circuits that are configured to control execution of programs in the solutions in this application.

The communication line 202 may include a path on which information is transferred between the foregoing components.

The communication interface 204 is configured to communicate with another device. In embodiments of this application, the communication interface may be a module, a circuit, a bus, an interface, a transceiver, or another apparatus that can implement a communication function, and is configured to communicate with another device. Optionally, when the communication interface is the transceiver, the transceiver may be an independently disposed transmitter, and the transmitter may be configured to send information to another device. Alternatively, the transceiver may be an independently disposed receiver, and is configured to receive information from another device. Alternatively, the transceiver may be a component that integrates functions of sending and receiving information. Specific implementation of the transceiver is not limited in embodiments of this application.

The memory 203 may be a read-only memory (ROM) or another type of static storage device that can store static information and instructions, or a random access memory (RAM) or another type of dynamic storage device that can store information and instructions. The memory 203 may alternatively be an electrically erasable programmable read-only memory (EEPROM), a compact disc read-only memory (CD-ROM) or another compact disc storage, optical disc storage (including a compressed optical disc, a laser disc, an optical disc, a digital versatile disc, a Blu-ray disc, or the like), or magnetic disk storage medium or another magnetic storage device, or any other medium that can be used to carry or store expected program code in a form of instructions or a data structure and that is accessible to a computer, but is not limited thereto. The memory may exist independently, and is connected to the processor through the communication line 202. The memory may alternatively be integrated with the processor.

The memory 203 is configured to store computer-executable instructions for implementing the solutions of this application, and the processor 201 controls the execution. The processor 201 is configured to execute the computer-executable instructions stored in the memory 203, to implement an application download method provided in the following embodiments of this application.

Optionally, the computer-executable instructions in embodiments of this application may also be referred to as application program code, instructions, a computer program, or another name. This is not specifically limited in embodiments of this application.

During specific implementation, in an embodiment, the processor 201 may include one or more CPUs, such as a CPU 0 and a CPU 1 in FIG. 3.

During specific implementation, in an embodiment, the server may include a plurality of processors, such as the processor 201 and a processor 205 in FIG. 3. Each of the processors may be a single-core (single-CPU) processor, or may be a multi-core (multi-CPU) processor. The processor herein may be one or more devices, circuits, and/or processing cores configured to process data (for example, computer program instructions).

In some embodiments, after receiving, through the communication interface 204, an application download request sent by the electronic device 200, the server 100 determines, through the processor 201, an application package that the electronic device 200 requests to download and device information of the electronic device 200. The device information includes, for example, a device type, a language type, a CPU model, and a resolution. Then, the server 100 may perform unpacking processing on the application package based on the device information, and determine a running resource that is in the application package and that is required by the electronic device 200 to run the to-be-downloaded application. The running resource is used to support running of the to-be-downloaded application in the electronic device 200.

In some examples, the server 100 may pack and deliver the running resource to the electronic device 200 through the communication interface 204, to reduce the size of the application package and increase an application download speed.

In some other examples, the server 100 may further perform unpacking processing on the running resource, and split the running resource into resources required for starting the application, for example, a set of resources for opening a home page of the application, and resources required after the application is started, for example, a set of resources for opening a function page of the application. Then, the server 100 may first pack, through the communication interface 204, resources required for starting the application, and then deliver packed resources to the electronic device 200 through the communication interface 204, thereby improving an application download and startup speed. Then, the server 100 packs the resources required after the application is started and delivers packed resources to the electronic device 200 through the communication interface 204, to ensure subsequent normal running of the application.

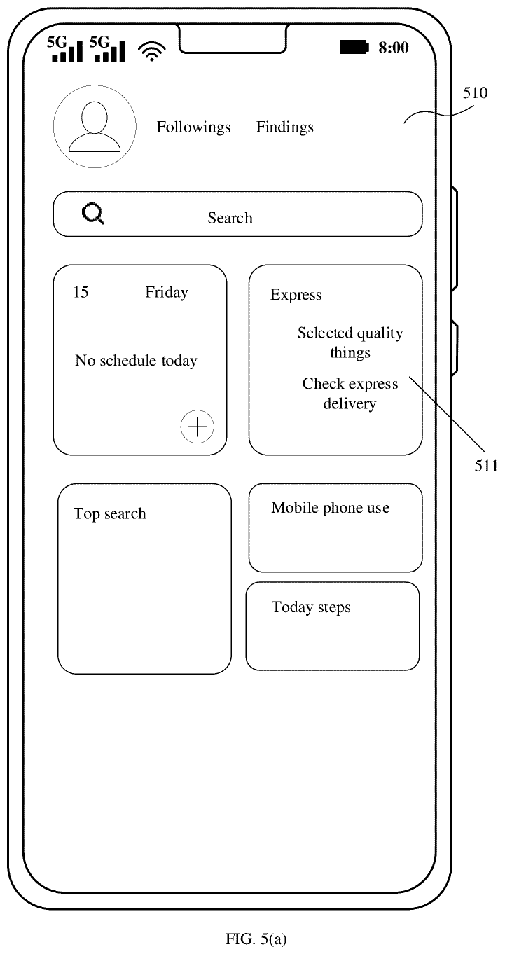

For example, FIG. 4 is a diagram of a structure of the electronic device.

The electronic device may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a sensor module 180, a button 190, a motor 191, an indicator 192, a camera 193, a display 194, a subscriber identity module (SIM) interface 195, and the like.

It may be understood that the structure shown in this embodiment of this application does not constitute a specific limitation on the electronic device. In some other embodiments of this application, the electronic device may include more or fewer components than those shown in the figure, or combine some components, or split some components, or have a different component arrangement. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, a neural-network processing unit (NPU), and/or the like. Different processing units may be independent components, or may be integrated into one or more processors.

A memory may be further disposed in the processor 110, and is configured to store instructions and data. In some embodiments, the memory in the processor 110 is a cache memory. The memory may store instructions or data that has been used or cyclically used by the processor 110. If the processor 110 needs to use the instructions or the data again, the processor 110 may directly invoke the instructions or the data from the memory. This avoids repeated access, reduces waiting time of the processor 110, and improves system efficiency.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The USB interface 130 is an interface that conforms to a USB standard specification, and may be specifically a mini USB interface, a micro USB interface, a USB type-C interface, or the like. The USB interface 130 may be configured to connect to a charger to charge the electronic device, or may be configured to perform data transmission between the electronic device and a peripheral device, or may be configured to connect to a headset for playing audio through the headset. The interface may be further configured to connect to another first electronic device, for example, an AR device.

The charging management module 140 is configured to receive a charging input from a charger. The charger may be a wireless charger or a wired charger. In some embodiments of wired charging, the charging management module 140 may receive a charging input of the wired charger through the USB interface 130. In some embodiments of wireless charging, the charging management module 140 may receive a wireless charging input by using a wireless charging coil of the electronic device. The charging management module 140 may further supply power to the first electronic device through the power management module 141 while charging the battery 142.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communication module 160, and the like. The power management module 141 may be further configured to monitor parameters such as a battery capacity, a battery cycle count, and a battery health status (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the electronic device may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna of the electronic device may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 150 may provide a solution to wireless communication such as 2G/3G/4G/5G applicable to the electronic device. The mobile communication module 150 may include at least one filter, a switch, a power amplifier, a low noise amplifier (LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1. In some embodiments, at least some functional modules in the mobile communication module 150 may be disposed in the processor 110. In some embodiments, at least some functional modules of the mobile communication module 150 may be disposed in a same device as at least some modules of the processor 110.

The wireless communication module 160 may provide a wireless communication solution that is applied to the electronic device, and that includes a wireless local area network (WLAN) (for example, a Wi-Fi network), Bluetooth (BT), a global navigation satellite system (GNSS), frequency modulation (FM), a near field communication (NFC) technology, an infrared (IR) technology, or the like. The wireless communication module 160 may be one or more devices integrating at least one communication processing module. The wireless communication module 160 receives an electromagnetic wave through the antenna 2, performs frequency modulation and filtering processing on the electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2.

In some embodiments, in the electronic device, the antenna 1 and the mobile communication module 150 are coupled, and the antenna 2 and the wireless communication module 160 are coupled, so that the electronic device can communicate with a network and another device by using a wireless communication technology. The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

The electronic device implements a display function through the GPU, the display 194, the application processor, and the like. The GPU is a microprocessor for image processing, and is connected to the display 194 and the application processor. The GPU is configured to perform mathematical and geometric computation, and render an image. The processor 110 may include one or more GPUs that execute program instructions to generate or change display information.

The display 194 is configured to display an image, a video, and the like. The display 194 includes a display panel. The display panel may be a liquid crystal display (LCD), for example, an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the electronic device may include one or N displays 194, where N is a positive integer greater than 1.

In some embodiments, in response to an operation of a user on the display 194, the electronic device 200 determines that the user indicates to download an application, and may send an application download request to the server 100 through the wireless communication module 160. The application download request carries device information of the electronic device 200.

Subsequently, the electronic device 200 may receive, through the wireless communication module 160, an application package delivered by the server 100, and after completing installation of the application by using the processor 110, display the application through the display 194.

The camera 193 is configured to capture a static image or a video. An optical image of an object is generated through a lens, and is projected onto the photosensitive element. The photosensitive element may be a charge coupled device (CCD), or a complementary metal-oxide-semiconductor (CMOS) phototransistor. The photosensitive element converts an optical signal into an electrical signal, and then transfers the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the electronic device may include one or N cameras 193, where N is a positive integer greater than 1.

The external memory interface 120 may be configured to connect to an external storage card, for example, a microSD card, to extend a storage capability of the electronic device. The external memory card communicates with the processor 110 through the external memory interface 120, to implement a data storage function. For example, files such as music and videos are stored in the external storage card.

The internal memory 121 may be configured to store computer-executable program code. The executable program code includes instructions. The internal memory 121 may include a program storage area and a data storage area. In addition, the internal memory 121 may include a high-speed random access memory, and may further include a nonvolatile memory. The processor 110 runs the instructions stored in the internal memory 121 and/or the instructions stored in the memory disposed in the processor, to execute various function applications of the electronic device and data processing.

The audio module 170 is configured to convert digital audio information into an analog audio signal for output, and is further configured to convert analog audio input into a digital audio signal. The audio module 170 may be further configured to code and decode an audio signal. In some embodiments, the audio module 170 may be disposed in the processor 110, or some functional modules in the audio module 170 are disposed in the processor 110. The electronic device may implement an audio function such as music play and recording through the audio module 170. The audio module 170 may include a speaker, a receiver, a microphone, a headset jack, an application processor, and the like.

The sensor module 180 may include a pressure sensor, a gyro sensor, a barometric pressure sensor, a magnetic sensor, an acceleration sensor, a distance sensor, an optical proximity sensor, a fingerprint sensor, a temperature sensor, a touch sensor, an ambient light sensor, a bone conduction sensor, and the like.

The button 190 includes a power button, a volume button, and the like. The button 190 may be a mechanical button, or may be a touch button. The electronic device may receive a button input, and generate a button signal input related to user settings and function control of the electronic device.

The motor 191 may generate a vibration prompt. The motor 191 may be configured to provide an incoming call vibration prompt and a touch vibration feedback.

The indicator 192 may be an indicator light, and may be configured to indicate a charging status and a power change, or may be configured to indicate a message, a missed call, a notification, and the like.

The SIM card interface 195 is configured to connect to a SIM card. The electronic device may support one or N SIM card interfaces, where N is a positive integer greater than 1.

In some embodiments, in response to a user operation, the electronic device 200 determines that the user indicates to download an application, and may determine to send an application download request to the server 100.

In some examples, the user operation is, for example, an operation of the user on an application download link, an icon, a card, a control, or the like.

In some examples, the application includes, for example, a common application or an installation-free application. The common application includes, for example, an application that a user can choose to install or uninstall, such as an application like Health, AI Life, Notepad, or the like. The installation-free application includes, for example, a quick application and an applet. Although an application package also needs to be downloaded and installed for the installation-free application, a process of downloading or installing the application package is not perceived by the user. Therefore, the installation-free application is referred to as an installation-free application in this embodiment of this application.

In some examples, the application download request carries device information of the electronic device 200. The device information includes, for example, a device type, a language type, a CPU model, and a resolution. The device type includes, for example, a mobile phone, a tablet, and a smart screen. The language type includes, for example, a type of voice used by the device.

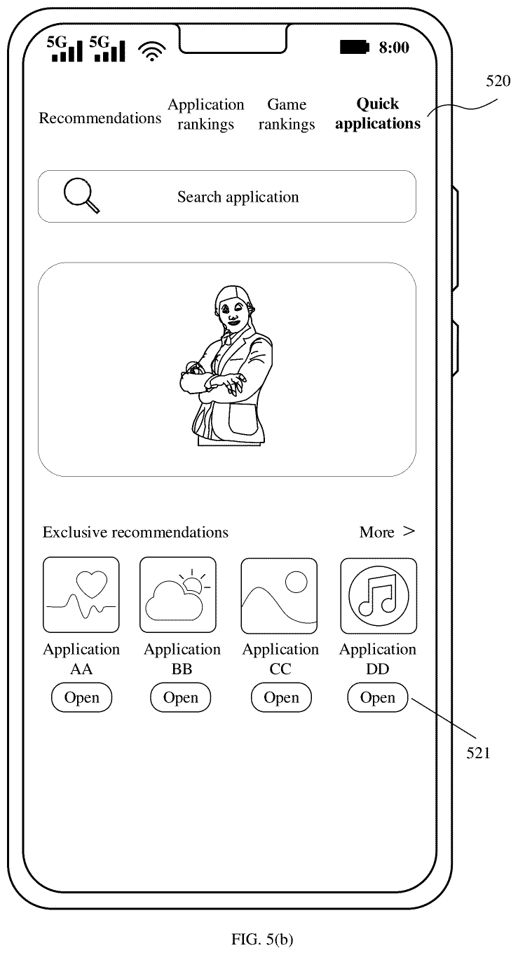

For example, an installation-free application may be displayed in a form of a card, for example, an interface 510 shown in FIG. 5(a). In a process of displaying a leftmost screen, the electronic device 200 detects an operation of the user on a card 511, and may start a corresponding ability, for example, an express delivery service. The ability is an implementation of the installation-free application. For example, when starting the ability for the first time, the electronic device 200 may send the application download request to the server 100, to request to download a corresponding application package. Subsequently, the electronic device 200 may start a corresponding ability based on the downloaded application package to display a corresponding page.

For another example, as shown in an interface 520 in FIG. 5(b), in a process of displaying the AppGallery, the electronic device 200 detects, on an interface of a quick application center, an operation of opening a control 521 by the user, and may determine that the user indicates to start a quick application corresponding to the control 521. In this case, the electronic device 200 may send the application download request to the server 100, to request to download a corresponding application package. Subsequently, the electronic device 200 may start a corresponding quick application based on the downloaded application package to display a corresponding page.

In some embodiments, after receiving the application download request sent by the electronic device 200, the server 100 may determine an application package corresponding to the application download request. The application package is an application package corresponding to an application that the electronic device 200 requests to download.

In some examples, the application package is, for example, an installation package used to install an application. Application package types supported by different operating systems may be different. For example, the application package is, for example, an installation package of an Android system (Android package, APK) or a HarmonyOS ability installation package (HarmonyOS ability package, HAP).

The following uses an example in which the application package is the HAP package of the HarmonyOS to describe in detail a process of unpacking the application package. It should be understood that for the APK package of the Android system, unpacking and downloading the application package may also be implemented based on this solution.

In some embodiments, the HAP package may be classified into an entry package and a feature package.

The entry package is a main module of an application. An application usually has an entry package. The entry package may be, for example, used to display an entry interface of the application, display an entry icon of the application, and implement a main feature function.

The feature package is a dynamic feature module of the application. An application may include one or more feature packages, or may not include the feature package. The feature package may be used to implement a feature function of the application, may be set to be downloaded and installed as required, or may be set to be downloaded and installed together with the entry package.

In some other examples, when an installation-free application has only one installation package, and the installation-free application runs based on the installation package, the installation package may be defined as the entry package.

In some embodiments, an application package that includes a component can independently run. In the HAP package of the HarmonyOS, the component is an ability. In the APK package of the Android system, the component is an activity. In this case, use the HAP package as an example. After determining the HAP package, the electronic device 200 may determine resource information of MainAbility. The resource information of the MainAbility indicates main resources for running an application in the HAP package. The main resources may be used to support running of the application in different types of electronic devices, and may be used to implement different functions of the application.

In some embodiments, after obtaining the corresponding application package based on the application download request, the server 100 may parse the application package, and determine the entry package included in the application package based on the resource information of the MainAbility. Then, the server 100 may split the entry package based on the device information carried in the application download request, and determine a running resource that is in the application package and that is required by the electronic device 200 to run the to-be-downloaded application.

For example, different resolutions may be set for electronic devices of a same type, and there is a specific difference between resources that need to be used by the different resolutions. Therefore, the server 100 may determine, based on the resolution included in the device information, resources that are required by the resolution of the electronic device 200 and that are in the entry package.

For another example, processors (CPUs) of different models may be set for different electronic devices, and there is a specific difference between resources that need to be used by the processors of different models. Therefore, the server 100 may determine, based on the CPU model included in the device information, resources that are required by the CPU model of the electronic device 200 and that are in the entry package. In some examples, the CPU model includes two fields. One field indicates a platform, and the other field indicates a word size. For example, a platform of a CPU with an advanced RISC machine (ARM) 64 model is ARM, and a word size is 64 bits. A platform of a CPU with an x86 model is a Windows® platform, and a word size is 32 bits. The server 100 may determine, based on the platform and a byte of the CPU of the electronic device 200, resources that need to be used for running the CPU. It should be understood that the server 100 may also obtain the device information of the electronic device 200 in another manner. For example, in another process of communicating with the electronic device 200, the server 100 may obtain the device information of the electronic device 200. For another example, when establishing a communication connection to the server 100 for the first time, the electronic device 200 actively reports the device information. A manner in which the server 100 obtains the device information of the electronic device 200 is not specifically limited in this embodiment of this application.

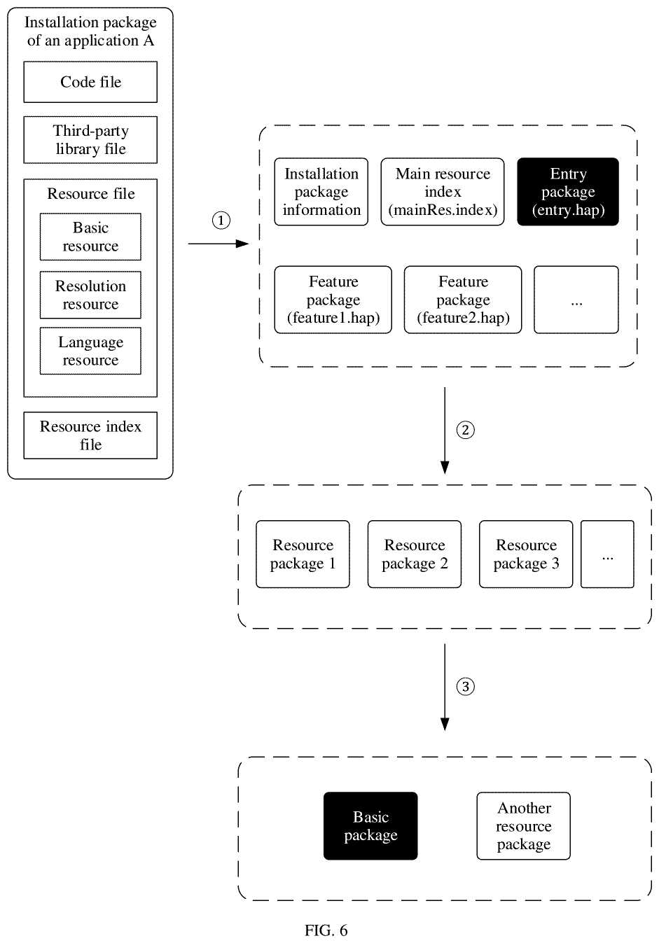

For example, as shown in FIG. 6, after obtaining an installation package of an application A based on the application download request, the server 100 parses the installation package of the application A, to determine the entry package included in the installation package of the application A. Then, the server 100 may split the entry package based on the device information carried in the application download request, and split the entry package into different resource packages. Then, the server 100 may determine a running resource corresponding to the device information, and pack the running resource into a basic package, that is, finally split the entry package into the basic package and another resource package.

In some embodiments, after completing splitting of the basic package, the server 100 may deliver the basic package to the electronic device 200 that requests to download an application. Correspondingly, after obtaining the basic package, the electronic device 200 may install the application.

For example, the server 100 determines that resolution resources in the entry package include a 1024×1024 resolution resource, a 256×256 resolution resource, and the like. The server 100 determines that a resolution of the electronic device 200 is 1024×1024 based on the device information of the electronic device 200. In this case, in a process of splitting the entry package, the server 100 may split the 1024×1024 resolution resource that is included in the entry package into the running resource, and subsequently pack the running resource into the basic package. In this way, the electronic device 200 subsequently downloads the basic package to install the application, and does not need to download an unnecessary resolution resource.

For another example, the server 100 determines that resources corresponding to the CPU model in the entry package include a resource for a CPU with an ARM 64 model, a resource for a CPU with an x86 model, and the like. The server 100 determines, based on the device information of the electronic device 200, that the CPU model set for the electronic device 200 is ARM 64. In this case, in the process of splitting the entry package, the server 100 may split the resource that is included in the entry package and that is for the CPU with the ARM 64 model into the running resource, and subsequently pack the running resource into the basic package. In this way, the electronic device 200 subsequently downloads the basic package to install the application, and does not need to download an unnecessary resource corresponding to the CPU model.

In this way, the server 100 splits the application package, and retains a running resource that is required by the electronic device 200 to run the application and that is for the electronic device 200 to download, which reduces a size of the application package and avoids downloading a redundant resource, thereby increasing an application download speed. In addition, a waste of download traffic caused by downloading the redundant resource can be avoided.

It should be understood that retention of the running resource ensures that the electronic device 200 can normally run the application after the application is downloaded, thereby effectively improving a speed at which the electronic device 200 starts the application for the first time, reducing waiting duration of a user, and meeting an application use requirement of the user.

In addition, a decrease in the size of the application package also reduces storage space occupied by the application package on the electronic device 200, so that performance of the electronic device 200 is improved.

In some embodiments, the basic package includes a set of resources for opening a home page of an application and a set of resources for opening a function page of the application. The set of resources for opening the home page of the application includes, for example, image resources and a language package that are required for displaying the home page of the application. The set of resources for opening the function page of the application include, for example, resources that are required for displaying the function page of a corresponding application.

In this case, after downloading the basic package, the electronic device 200 may display the home page of the application based on the set of resources that are included in the basic package and that are used to open the home page of the application. In other words, the electronic device 200 needs to use only some resources included in the basic package to start the application, and other resources may be used in a subsequent running process of the application.

Therefore, the server 100 may split the basic package again, to further reduce the size of the application package and improve the speed at which the application is started.

In some embodiments, the server 100 splits the basic package in an ability dimension based on the determined resource information of the MainAbility, and splits the basic package into a home page package and a non-home page package. The home page package includes the set of resources for opening the home page of the application. The non-home page package includes the set of resources for opening the function page of the application. Then, the server 100 may deliver the home page package to the electronic device 200. In this way, the electronic device 200 may start the installation-free application based on the obtained home page package, to display the installation-free application.

For example, after downloading and installing the home page package, the electronic device 200 may display the home page of the installation-free application. Therefore, the set of resources that are included in the home page package and that are used to open the home page of the application are used to display the home page, for example, including resources such as image resources, control resources, and text resources on the home page. In this way, the electronic device 200 can quickly start a corresponding installation-free application by downloading and installing a home page package of a small size, to display the home page of the installation-free application.

For another example, the electronic device 200 needs to jump to another function page in response to an operation of the user on the home page. In this case, the electronic device 200 needs to obtain the resources included in the non-home page package, to display the another function page. For example, the resources included in the non-home page package are resources such as the image resources, the control resources, and the text resources that are used to display the another function page that is jumped to.

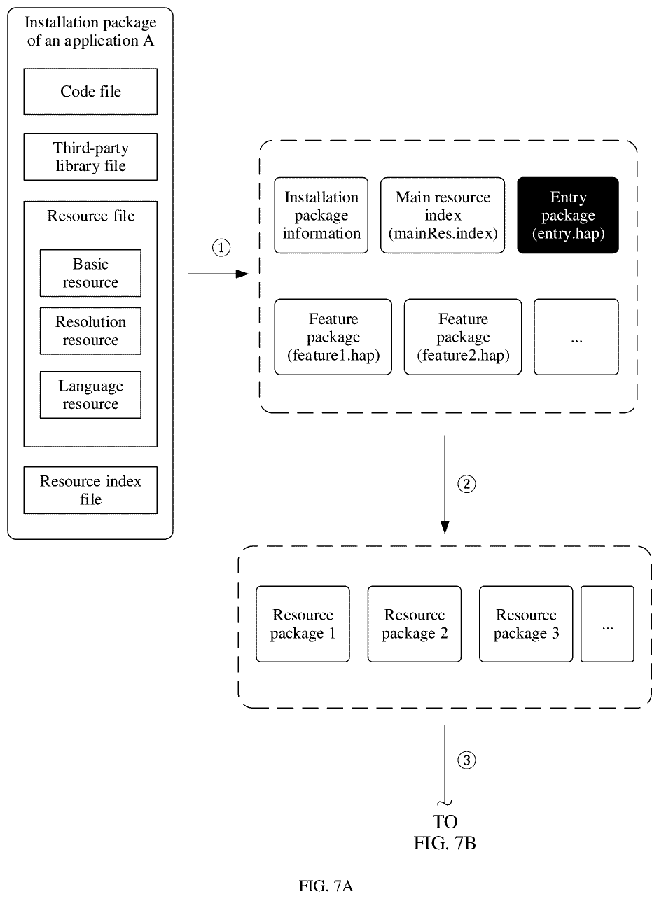

For example, as shown in FIG. 7A and FIG. 7B, the server 100 splits an installation package (for example, an installation package of an application A) of an installation-free application based on the method described in the foregoing embodiments, to complete packing of a basic package and another resource package. Then, the server 100 splits the basic package again based on the resource information of the MainAbility, and splits the basic package into a home page package of the application A and a non-home page package of the application A.

In some examples, as shown in FIG. 7A and FIG. 7B, the basic package includes a code file, a resource file, and a resource index file. The code file includes code files such as an ApplicationStage code file that is used to provide a general function such as reading a file by an application, MainAbility code file that is used to provide a main service capability of an application package, and a MainPage code file that is used to display a home page. These code files are used to implement different functions of an application after the application package is installed, and have a small size. Therefore, the server 100 may reserve these code files in the home page package. A size of the resource file is large. Therefore, the server 100 may split the resource file based on the resource index file such as the resource information of the MainAbility, and splits the main basic resources that are included in the resource file into the home page package. These main basic resources are a set of resources for opening the application. Then, the server 100 may split other remaining basic resources, in the resource file of the basic package, into the non-home page package. These other basic resources are a set of resources for opening a function page of the application.

In this case, as shown in FIG. 7A and FIG. 7B, after the server 100 splits the basic package, the split home page package of the application A includes the code file, the main basic resources, and the resource index file that indicates the main basic resources. The split non-home page package of the application A includes another basic resource and a resource index file that indicates the anotherbasic resource.

Then, the server 100 may deliver the home page package of the application A to the electronic device 200. Correspondingly, the electronic device 200 may display the home page of the application A based on the received home page package of the application A.

To more obviously reflect beneficial effect of the application download method provided in this embodiment of this application, Table 1 below describes differences between a complete application package and a complete home page package in terms of an application package size, download time consumed, and installation time consumed.

It can be seen that the server 100 unpacks the application package twice, and the size of the obtained home page package is obviously less than the size of the complete application package. Correspondingly, the time consumed for downloading the home page package is obviously less than the time consumed for downloading the complete application package. As described in Table 1, the size of the complete application package is 13 megabytes (M). When a network speed is 2 M/s, it takes 6.5 seconds (s) for the electronic device 200 to complete downloading of the complete application package. However, the size of the home page package is 3.95 M. When the network speed is 2 M/s, the electronic device 200 can complete downloading of the application package only in 1.98 s. In this case, the electronic device 200 starts the installation-free application by downloading the home page package, which can save time of 4.52 s. In addition, the installation time of the home page package is less than that of the complete application package. For example, 130 milliseconds (ms) can be saved.

In this way, the electronic device 200 may complete downloading and installation of the home page package in a short time in response to a user operation that indicates to download an application. Thus, the home page of the application is displayed without user awareness, and a requirement of the user for quick startup of an installation-free application is met.

TABLE 1

| | Complete application package | | Home page package | |
|---|---|---|---|---|
| Application | 13M | | 3.95M | |
| package size | | | | |
| Download time | 6.5 | s | 1.98 | s |
| consumed | | | | |
| (Network speed: | | | | |
| 2 M/s) | | | | |
| Installation time | 160 | ms | 30 | ms |
| consumed | | | | |

In conventional technologies, the electronic device 200 can run the application only after the complete installation package is downloaded. As a result, the user waits for an excessively long time to download the application. According to the application download method provided in this embodiment of this application, the application package is split, and the electronic device 200 needs to download only a set of resources for opening a home page of the application in the complete application package, thereby effectively improving application download efficiency and providing unaware application download and installation experience for the user.

In addition, a further decrease in the size of the application package reduces storage space occupied by the application package on the electronic device 200, so that performance of the electronic device 200 is improved.

In some embodiments, after the application is started, resources in the non-home page package need to be used for subsequent running of the application. Therefore, the electronic device 200 may further download the non-home page package, to ensure subsequent running of the application and meet a use requirement of the user.

For example, after completing downloading of the home page package, the electronic device 200 may install the home page package. Then, the electronic device 200 may download and install the non-home page package. In this case, after completing the installation of the non-home page package, the electronic device 200 may support the application in running another page.

For example, in a process of displaying the home page of the application based on the resources included in the home page package, the electronic device 200 detects an operation of the user on a control, and determines another page, of the application, that needs to be jumped to. In this case, the electronic device 200 may obtain corresponding resources from the non-home page package in response to the user operation, to jump to a corresponding page.

In this way, the size of the application package is reduced, and application startup time is reduced, thereby ensuring subsequent running of the application.

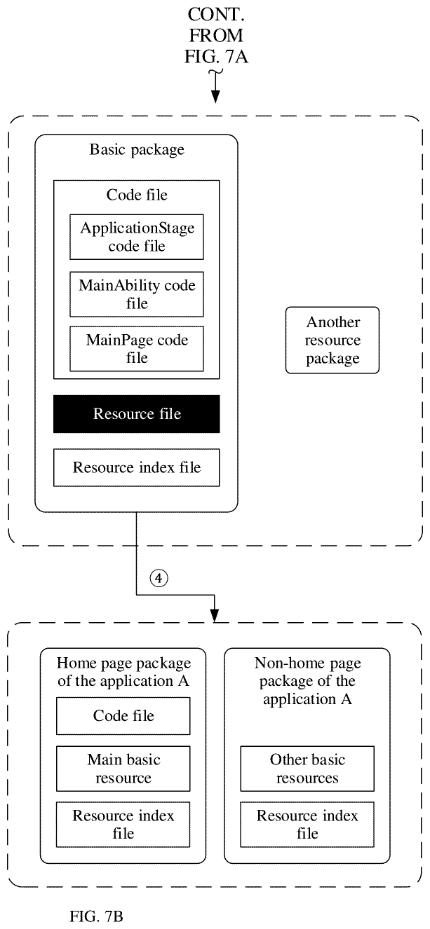

For another example, as shown in FIG. 8, after completing downloading of the home page package of the application A, the electronic device 200 may install the home page package of the application A. In addition, during or after the installation of the home page package of the application A, the electronic device 200 may request the server 100 to download the non-home page package of the application A, and install the non-home page package of the application A after the non-home page package of the application A is downloaded. Correspondingly, the server 100 may deliver the non-home page package of the application A to the electronic device 200 in response to the request of the electronic device 200. Subsequently, the electronic device 200 may display another page of the application A based on the resources included in the non-home page package of the application A.

A package management service in the electronic device 200 may be used to parse and install the application package.

In this way, there is no need to wait until the home page package is downloaded and installed before downloading of the non-home page package. Instead, an installation process of the home page package and a download process of the non-home page package are performed in parallel, so that overall time for downloading and installing the home page package and the non-home page package is reduced, thereby reducing time for starting the application and further reducing waiting time for subsequent running of the application.

For another example, after completing downloading and installation of the home page package, the electronic device 200 may request the server 100 to download the non-home page package, and then may install the non-home page package. In this case, after completing the installation of the non-home page package, the electronic device 200 may support the application in running another function page.

In this way, when efficiency of displaying the home page of the application is improved, the non-home page package is used to ensure that the application displays the another function page.

For still another example, after the electronic device 200 completes downloading and installation of the home page package, the application starts the application based on the home page package, and displays the home page of the application. Then, in a process of displaying the home page, the electronic device 200 detects an operation of the user, determines the operation that indicates to display another function page, may request the server 100 to download the non-home page package, and then may install the non-home page package. In this case, after completing the installation of the non-home page package, the electronic device 200 may display the function page that the user indicates to display.

In this way, when efficiency of displaying the home page of the application is improved, the non-home page package is used to ensure that the application displays the another function page.

In some examples, after splitting the basic package into the home page package and the non-home page package, the server 100 may deliver both the home page package and the non-home page package to the electronic device 200. Correspondingly, the electronic device 200 may choose to preferentially download the home page package, and download the non-home page package after the home page package is downloaded. That is, the server 100 may choose to separately deliver the home page package and the non-home page package, or deliver both the home page package and the non-home page package in response to the request of the electronic device 200.

The foregoing uses the HAP package as an example to describe the splitting process of the application package, for example, the process of splitting the basic package in the entry package, and a secondary splitting process, for example, the process of splitting the basic package into the home page package and the non-home page package. It should be understood that names of application packages are the same or different in different operating systems. Names of the entry package, the basic package, the home page package, and the non-home page package are merely examples for description. The names are not limited in this embodiment of this application.

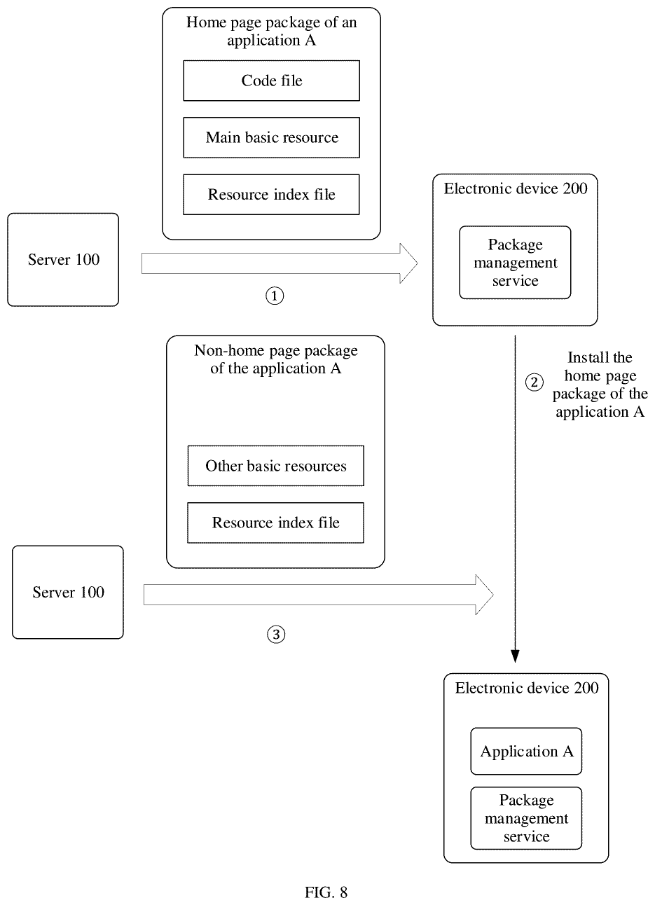

For example, FIG. 9 is a schematic flowchart of an application download method according to an embodiment of this application. As shown in FIG. 9, the method includes the following steps.

S901: The electronic device sends a first application download request to a server in response to a first operation of a user, where the first application download request carries device information of the electronic device and information about a first application that the first operation indicates to download.

The device information includes one or more of a device type, a language type, a processor model, and a resolution. The first operation is, for example, an operation of the user on an application download link, an icon, a card, a control, or the like.

In some embodiments, the electronic device sends the first application download request to the server in response to the first operation through which the user indicates to download the first application. In addition, the electronic device carries, in the first application download request, the device information of the electronic device and the information about the first application that is to be downloaded, to download the first application.

In some examples, the information about the first application includes, for example, an identifier that indicates the first application.

For example, an installation-free application may be displayed in a form of a card, for example, an interface 510 shown in FIG. 5(a). In a process of displaying a leftmost screen, the electronic device 200 detects an operation of the user on a card 511, and may start a corresponding ability, for example, an express delivery service. The ability is an implementation of the installation-free application. For example, when starting the ability for the first time, the electronic device 200 may send the application download request to the server 100, to request to download a corresponding application package.

S902: The server determines, based on the information about the first application, a first application package corresponding to the first application.

In some embodiments, the server receives the first application download request sent by the electronic device, and may determine, based on the information about the first application carried in the first application download request, the first application package corresponding to the first application that is requested to be downloaded.

S903: The server performs unpacking processing on the first application package based on the device information, and splits an entry package in the first application package into a basic package and another resource package.

The basic package includes a set of resources used by the electronic device to run the first application.

In some embodiments, after determining the first application package, the server may determine the entry package in the first application package. Then, the server may perform unpacking processing on the entry package, determine, based on the device information of the electronic device, the set of resources used by the electronic device to run the first application, and pack the set of these resources into the basic package.

For example, as shown in FIG. 6, after obtaining an installation package of an application A based on the application download request, the server 100 parses the installation package of the application A, to determine the entry package included in the installation package of the application A. Then, the server 100 may split the entry package based on the device information carried in the application download request, and split the entry package into different resource packages. Then, the server 100 may determine a running resource corresponding to the device information, and pack the running resource into a basic package, that is, finally split the entry package into the basic package and another resource package.

For example, the server 100 determines that resolution resources in the entry package include a 1024×1024 resolution resource, a 256×256 resolution resource, and the like. The server 100 determines that a resolution of the electronic device 200 is 1024×1024 based on the device information of the electronic device 200. In this case, in a process of splitting the entry package, the server 100 may split the 1024×1024 resolution resource that is included in the entry package into the running resource, and subsequently pack the running resource into the basic package. In this way, the electronic device 200 subsequently downloads the basic package to install the application, and does not need to download an unnecessary resolution resource.

S904: The server sends the basic package to the electronic device.

In some embodiments, after determining the basic package, the server may send the basic package to the electronic device. Correspondingly, the electronic device receives the basic package sent by the server.

S905: The electronic device displays the first application based on the basic package.

In some embodiments, after receiving the basic package, the electronic device may display the first application based on the resource set in the basic package.

In this way, the server splits the application package, and retains a running resource that is required by the electronic device to run the application and that is for the electronic device to download, which reduces a size of the application package and avoids downloading a redundant resource, thereby increasing an application download speed. In addition, a waste of download traffic caused by downloading the redundant resource can be avoided.

It should be understood that retention of the running resource ensures that the electronic device can normally run the application after the application is downloaded, thereby effectively improving a speed at which the electronic device starts the application for the first time, reducing waiting duration of a user, and meeting an application use requirement of the user.

In addition, a decrease in the size of the application package also reduces storage space occupied by the application package on the electronic device, so that performance of the electronic device is improved.

In some embodiments, the server may further perform unpacking processing on the basic package, and split the basic package into a home page package and a non-home page package. The home page package includes a set of resources for opening a home page of the first application. The non-home page package includes a set of resources for opening a function page of the first application.

In some examples, the server sends the home page package to the electronic device. Correspondingly, the electronic device receives the home page package sent by the server. Then, the electronic device may display the home page of the first application based on the home page package.

For example, as shown in FIG. 7A and FIG. 7B, the server 100 may split a resource file based on a resource index file such as resource information of MainAbility, and splits main basic resources that are included in the resource file into the home page package. These main basic resources are the set of resources for opening the home page of the application. In addition, the server 100 may retain a code file, in the basic package, in the home page package. Then, the server 100 may split other remaining basic resources, in the resource file of the basic package, into the non-home page package. These other basic resources are the set of resources for opening the function page of the application.

In this way, the server splits the basic package, and retains the set of resources for opening the home page of the application by the electronic device, so that application startup efficiency is further improved while it is ensured that the application is started and the home page is displayed.

In some embodiments, in a process of displaying the home page of the first application, the electronic device detects a second operation of the user. The second operation indicates to jump to the function page of the first application. In some examples, after completing downloading of the home page package, the electronic device sends a second application download request to the server. Alternatively, the electronic device sends a second application download request to the server in response to the second operation. The second application download request is used to request to download resources that are used to display another function page of the first application.

Correspondingly, the server receives the second application download request sent by the electronic device. The second application download request is a request sent by the electronic device during or after installation of the home page package. The server sends the non-home page package to the electronic device in response to the second application download request. The non-home page package is used by the electronic device to display the function page of the first application.

In this way, there is no need to wait until the home page package is downloaded and installed before downloading of the non-home page package. Instead, an installation process of the home page package and a download process of the non-home page package are performed in parallel, so that overall time for downloading and installing the home page package and the non-home page package is reduced, thereby reducing time for starting the application and further reducing waiting time for subsequent running of the application.

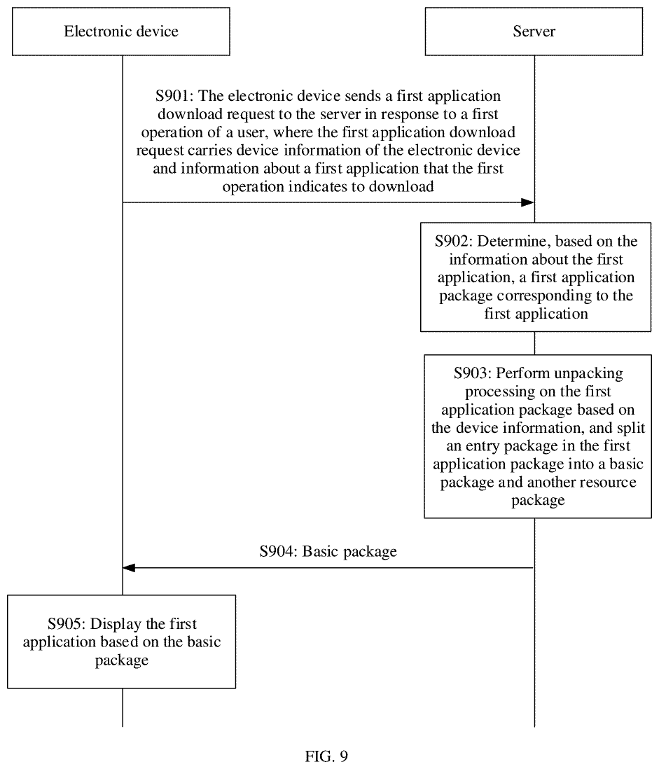

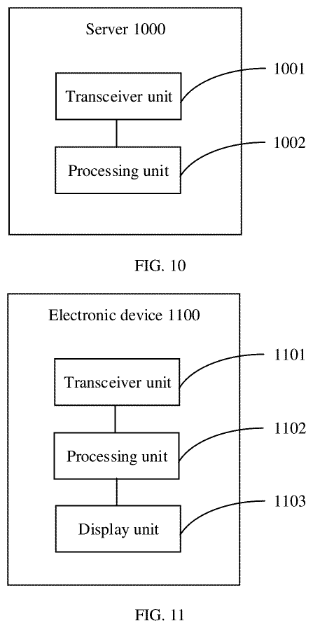

The foregoing describes in detail the application download method provided in embodiments of this application with reference to FIG. 5(a) and FIG. 5(b) to FIG. 9. The following describes in detail a server provided in an embodiment of this application with reference to FIG. 10, and describes in detail an electronic device provided in an embodiment of this application with reference to FIG. 11.

In a possible design, FIG. 10 is a diagram of a structure of the server according to an embodiment of this application. As shown in FIG. 10, the server 1000 may include a transceiver unit 1001 and a processing unit 1002. The server 1000 may be configured to implement functions of the server 100 in the foregoing method embodiments.

Optionally, the transceiver unit 1001 is configured to support the server 1000 in performing S901 and S904 in FIG. 9.

Optionally, the processing unit 1002 is configured to support the server 1000 in performing S902 and S903 in FIG. 9.

The transceiver unit may include a receiving unit and a sending unit, may be implemented by a transceiver or a transceiver-related circuit component, and may be a transceiver or a transceiver module. Operations and/or functions of the units in the server 1000 are respectively intended to implement corresponding procedures of the application download method in the foregoing method embodiments. All related content of the steps in the foregoing method embodiments may be referenced to function descriptions of corresponding functional units. For brevity, details are not described herein again.

Optionally, the server 1000 shown in FIG. 10 may further include a storage unit (not shown in FIG. 10), and the storage unit stores a program or instructions. When the transceiver unit 1001 and the processing unit 1002 execute the program or the instructions, the server 1000 shown in FIG. 10 may perform the application download method in the foregoing method embodiments.

For technical effect of the server 1000 shown in FIG. 10, refer to the technical effect of the application download method provided in the foregoing method embodiments. Details are not described herein again.

In addition to a form of the server 1000, the technical solutions provided in this application may also be a functional unit or a chip in the server, or an apparatus that matches the server.

In a possible design, FIG. 11 is a diagram of a structure of the electronic device according to an embodiment of this application. As shown in FIG. 11, the electronic device 1100 may include a transceiver unit 1101, a processing unit 1102, and a display unit 1103. The electronic device 1100 may be configured to implement functions of the electronic device 200 in the foregoing method embodiments.

Optionally, the transceiver unit 1101 is configured to support the electronic device 1100 in performing S901 and S904 in FIG. 9.

Optionally, the processing unit 1102 is configured to support the electronic device 1100 in performing S905 in FIG. 9.

Optionally, the display unit 1103 is configured to support the electronic device 1100 in performing S905 in FIG. 9.

The transceiver unit may include a receiving unit and a sending unit, may be implemented by a transceiver or a transceiver-related circuit component, and may be a transceiver or a transceiver module. Operations and/or functions of the units in the electronic device 1100 are respectively intended to implement corresponding procedures of the application download method in the foregoing method embodiments. All related content of the steps in the foregoing method embodiments may be referenced to function descriptions of corresponding functional units. For brevity, details are not described herein again.

Optionally, the electronic device 1100 shown in FIG. 11 may further include a storage unit (not shown in FIG. 11), and the storage unit stores a program or instructions. When the transceiver unit 1101, the processing unit 1102, and the display unit 1103 execute the program or the instructions, the electronic device 1100 shown in FIG. 11 may perform the application download method in the foregoing method embodiments.

For technical effect of the electronic device 1100 shown in FIG. 11, refer to the technical effect of the application download method provided in the foregoing method embodiments. Details are not described herein again.

In addition to a form of the electronic device 1100, the technical solutions provided in this application may also be a functional unit or a chip in the electronic device, or an apparatus that matches the electronic device.

An embodiment of this application further provides a chip system, including a processor. The processor is coupled to a memory. The memory is configured to store a program or instructions. When the program or the instructions are executed by the processor, the chip system is enabled to implement the method according to any one of the foregoing method embodiments.

Optionally, there may be one or more processors in the chip system. The processor may be implemented by using hardware, or may be implemented by using software. When the processor is implemented by using the hardware, the processor may be a logic circuit, an integrated circuit, or the like. When the processor is implemented by using the software, the processor may be a general-purpose processor, and is implemented by reading software code stored in the memory.

Optionally, there may also be one or more memories in the chip system. The memory may be integrated with the processor, or may be disposed separately from the processor. This is not limited in embodiments of this application. For example, the memory may be a non-transitory processor, for example, a read-only memory ROM. The memory and the processor may be integrated into a same chip, or may be separately disposed on different chips. A type of the memory and a manner of disposing the memory and the processor are not specifically limited in embodiments of this application.

For example, the chip system may be a field programmable gate array (field programmable gate array, FPGA), an application-specific integrated circuit (application-specific integrated circuit, ASIC), a system on chip (system on chip, SoC), a central processing unit (central processing unit, CPU), a network processor (network processor, NP), a digital signal processor (digital signal processor, DSP), a microcontroller unit (microcontroller unit, MCU), a programmable logic device (programmable logic device, PLD), or another integrated chip.

It should be understood that the steps in the foregoing method embodiments may be completed by using an integrated logic circuit of hardware in the processor or instructions in a form of software. The steps of the method disclosed with reference to embodiments of this application may be directly performed by a hardware processor, or may be performed through a combination of hardware in the processor and a software module.

An embodiment of this application further provides a computer-readable storage medium. The computer-readable storage medium stores a computer program. When the computer program is run on a computer, the computer is enabled to perform the foregoing related steps, to implement the application download method in the foregoing embodiments.

An embodiment of this application further provides a computer program product. When the computer program product runs on a computer, the computer is enabled to perform the foregoing related steps, to implement the application download method in the foregoing embodiments.

In addition, an embodiment of this application further provides an apparatus. The apparatus may be specifically a component or a module. The apparatus may include one or more processors and memories that are connected to each other. The memory is configured to store a computer program. When the computer program is executed by the one or more processors, the apparatus is enabled to perform the application download method in the foregoing method embodiments.

The apparatus, the computer-readable storage medium, the computer program product, or the chip provided in embodiments of this application is configured to perform the corresponding method provided above. Therefore, for beneficial effect that can be achieved, refer to beneficial effect in the corresponding method provided above. Details are not described herein again.

The method or algorithm steps described in combination with the content disclosed in embodiments of this application may be implemented by hardware, or may be implemented by a processor by executing software instructions. The software instructions may include a corresponding software module. The software module may be stored in a random access memory (random access memory, RAM), a flash memory, a read-only memory (read-only memory, ROM), an erasable programmable read-only memory (erasable programmable ROM, EPROM), an electrically erasable programmable read-only memory (electrically EPROM, EEPROM), a register, a hard disk, a removable hard disk, a compact disc read-only memory (CD-ROM), or any other form of storage medium well known in the art. For example, a storage medium is coupled to a processor, so that the processor can read information from the storage medium and write information into the storage medium. Certainly, the storage medium may be a component of the processor. The processor and the storage medium may be located in an application-specific integrated circuit (application-specific integrated circuit, ASIC).

The descriptions in the foregoing implementations allow a person skilled in the art to clearly understand that, for a purpose of convenient and brief description, division of the foregoing functional modules is merely used as an example for illustration. In actual application, the foregoing functions can be allocated to different functional modules and implemented according to a requirement, that is, an inner structure of an apparatus is divided into different functional modules to implement all or some of the functions described above. For a specific working process of the foregoing system, apparatus, and unit, refer to a corresponding process in the foregoing method embodiments. Details are not described herein again.

In the several embodiments provided in this application, it should be understood that the disclosed method may be implemented in other manners. The foregoing described apparatus embodiment is merely an example. For example, division into the modules or units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the modules or units may be implemented in electronic, mechanical, or other forms.

In addition, functional units in embodiments of this application may be integrated into one processing unit, or each of the units may exist alone physically, or two or more units may be integrated into one unit. The integrated unit may be implemented in a form of hardware, or may be implemented in a form of a software functional unit.

The computer-readable storage medium includes but is not limited to any one of any medium that can store program code, for example, a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. An application download method, comprising:
receiving, by a server, a first application download request sent by an electronic device, wherein the first application download request carries device information of the electronic device and information about a first application that is requested to be downloaded;
determining, based on the information about the first application, a first application package corresponding to the first application;
performing, by the server, unpacking processing on the first application package based on the device information;
splitting an entry package in the first application package into a basic package and another resource package, wherein the basic package comprises a set of resources for running the first application by the electronic device; and
sending the basic package to the electronic device.

2. The method according to claim 1, further comprising:
performing unpacking processing on the basic package; and
splitting the basic package into a home page package and a non-home page package, wherein the home page package comprises a set of resources for opening a home page of the first application, and the non-home page package comprises a set of resources for opening a function page of the first application.

3. The method according to claim 2, wherein the sending the basic package to the electronic device comprises:
sending the home page package to the electronic device, wherein sending the home page package causes the electronic device to start the first application and display the home page of the first application using the home page package.

4. The method according to claim 3, wherein further comprising performing, after the sending the home page package to the electronic device:
receiving a second application download request sent by the electronic device, wherein the second application download request is a request sent by the electronic device during, or after, installation of the home page package; and
sending the non-home page package to the electronic device in response to the second application download request, wherein sending the non-home page package causes electronic device to display the function page of the first application using the non-home page package.

5. The method according to claim 1, wherein the device information comprises one or more of a device type, a language type, a processor model, or a resolution.

6. An application download method, comprising:
sending, by an electronic device, a first application download request to a server in response to a first operation of a user, wherein the first application download request carries device information of the electronic device and information about a first application that the first operation indicates to download;
receiving a basic package sent by the server based on the first application download request, wherein the basic package comprises a set of resources that are in an entry package of the first application and that are associated with running the first application by the electronic device; and
displaying the first application based on the basic package.

7. The method according to claim 6, wherein the receiving the basic package comprises:
receiving a home page package sent by the server, wherein the home page package comprises a set of resources that are in the basic package and that are associated with opening a home page of the first application.

8. The method according to claim 7, further comprising performing, after the receiving a home page package sent by the server:
installing the home page package;
sending a second application download request to the server during, or after, the installation of the home page package; and
receiving a non-home page package sent by the server, wherein the non-home page package comprises a set of resources that are in the basic package and that are associated with opening a function page of the first application.

9. The method according to claim 8, wherein the displaying the first application based on the basic package comprises:
displaying the home page of the first application based on the home page package.

10. The method according to claim 9, further comprising:
detecting, in a process of displaying the home page of the first application, a second operation of the user; and
jumping, based on the non-home page package, to the function page of the first application that the second operation indicates to display.

11. The method according to claim 9, further comprising performing, before the sending the second application download request to the server:
detecting, in a process of displaying the home page of the first application, a third operation of the user, wherein the third operation indicates to jump to the function page of the first application.

12. The method according to claim 6, wherein the device information comprises one or more of a device type, a language type, a processor model, or a resolution.

13. An electronic device, comprising:
at least one processor; and
at least one non-transitory computer readable memory, connected to the at least one processor and including computer program code, wherein the at least one non-transitory computer readable memory and the computer program code are configured, with the at least one processor, to cause the electronic device to perform at least:
sending a first application download request to a server in response to a first operation of a user, wherein the first application download request carries device information of the electronic device and information about a first application that the first operation indicates to download;
receiving a basic package sent by the server based on the first application download request, wherein the basic package comprises a set of resources that are in an entry package of the first application and that are associated with running the first application by the electronic device; and
displaying the first application based on the basic package.

14. The electronic device according to claim 13, wherein the at least one non-transitory computer readable memory and the computer program code are further configured, with the at least one processor, to cause the electronic device to perform:
receiving a home page package sent by the server, wherein the home page package comprises a set of resources that are in the basic package and that are associated with opening a home page of the first application.

15. The electronic device according to claim 14, wherein the at least one non-transitory computer readable memory and the computer program code are further configured, with the at least one processor, to cause the electronic device to perform:
installing the home page package;
sending a second application download request to the server during, or after, the installation of the home page package; and
receiving a non-home page package sent by the server, wherein the non-home page package comprises a set of resources that are in the basic package and that are associated with opening a function page of the first application.

16. The electronic device according to claim 15, wherein the at least one non-transitory computer readable memory and the computer program code are further configured, with the at least one processor, to cause the electronic device to perform:
displaying the home page of the first application based on the home page package.

17. The electronic device according to claim 16, wherein the at least one non-transitory computer readable memory and the computer program code are further configured, with the at least one processor, to cause the electronic device to perform:
detecting, in a process of displaying the home page of the first application, a second operation of the user; and
jumping, based on the non-home page package, to the function page of the first application that the second operation indicates to display.

18. The electronic device according to claim 16, wherein the at least one non-transitory computer readable memory and the computer program code are further configured, with the at least one processor, to cause the electronic device to perform:
detecting, in a process of displaying the home page of the first application, a third operation of the user, wherein the third operation indicates to jump to the function page of the first application.

19. The electronic device according to claim 13, wherein the device information comprises one or more of a device type, a language type, a processor model, or a resolution.

20. The electronic device according to claim 13, wherein the first application is an installation-free application, and wherein the first operation comprises an operation on an icon, a card, a control or an application download link.
